(19) United States
(12) Patent Application Publication
(10) Pub. No.: US 2002/0091051 A1
(43) Pub. Date: Jul. 11, 2002

(54) Paint roller with integrated core and natural cover and method and apparatus for production of same

(76) Inventor: Chandra Sekar, Searington, NY (US)

Correspondence Address: Eugene C. Rzucidlo, INTELLECTUAL PROPERTY GROUP, GREENBERG TRAURIG, LLP, 885 Third Avenue, 21st Floor, New York, NY, 10022, US

(21) Appl. No.: 09/941,222

(22) Filed: Aug. 28, 2001

Related U.S. Application Data
(62) Division of application No. 09/422,417, filed on Oct. 21, 1999, now abandoned.

(51) Int. Cl. B31C 3/00

(52) U.S. Cl. 493/269

(57) ABSTRACT

A method and apparatus for making a paint roller having a natural skin cover are provided. The natural skin cover being bonded to the paint roller using a thermoplastic material, preferably polypropylene, and the natural skin cover being formed from a strip of natural skin, such as lambskin, provided in a width sufficient to accommodate shrinkage in the manufacturing process. The resulting product providing a superior natural skin covered paint roller that is substantially integral and that will remain integral when exposed to paint solvents.

### CROSS REFERENCE TO RELATED APPLICATION

This application claims priority under 35 U.S.C. §120 and 37 C.F.R. 1.53(b) from U.S. Utility Application No. 09/422,417 of Sekar, filed Oct. 21, 1999 which is hereby incorporated by reference in its entirety.

### FIELD OF THE INVENTION

This invention pertains to a method and apparatus for making paint rollers of the type used for applying paint to walls and the like. More specifically, the invention pertains to a method and apparatus for making paint rollers having thermoplastic (and preferably polypropylene) cores and a natural cover, such as lambskin.

### BACKGROUND OF THE INVENTION

Prior Art

Paint rollers are widely used by professionals and amateurs for applying paint to walls, ceilings, and other surfaces. Typically the roller is used with an applicator having a handle secured in a rotatable fashion thereto. The roller itself generally comprises a paint absorbing and spreading cover affixed to a generally cylindrical core. As is well known in the art, the cores may be made from cardboard, chipboard, phenolic, plastic, thermoplastics such as polypropylene, vinyl or other materials. Similarly, as is well known in the art, the covers may be made from materials such as wool, or woven polyamide or polyester fibers, or other cover materials.

In recent years, there have been many advances in the methods and apparatus for manufacturing paint rollers. Substantially all of the recent advances were directed to the manufacture of paint rollers with thermoplastic cores and covered with man-made fabrics. According to U.S. Pat. No. 5,855,715 (which is incorporated herein by this reference), the first paint rollers had lambskin covers but today, almost equal quality can be attained at a lower cost with woven and knitted polyamide or polyester fibers. (Citing Wahl: “Neuentwicklungen bei Farbrollern” Die Mappe 6/88, pp. 23-27.) The man-made fabrics lend themselves to the on-the-fly production methods disclosed, for example, in U.S. Pat. Nos. 4,692,975, 5,468,207, 5,862,591, 5,195,242, and 5,572,790, incorporated herein by this reference. The latter two being issued to the inventor of the present invention.

Despite the “almost equal quality” of the man-made fibers, many professionals still prefer rollers made from lambskin. Lambskin covered paint rollers and other paint rollers made from natural skins, however, are still hand-made and command a premium price.

The majority of hand-made lambskin rollers, as will be discussed in more detail below, are formed by sewing a tube of skin and sliding it down about a core. Others have also suggested the manufacture of paint rollers having natural skin covers wound about the core. While natural skin rollers with wound covers have been manufactured, they are plagued by problems, namely, that the glue cannot bond the cover to the core sufficiently to withstand repeated use for painting and with solvents. Unlike the sewn paint roller, which maintains itself through the strength of its seam, the wound natural skin paint roller relies on the glue bond to hold it to the core. This bond is easily weakened through use or by solvents, resulting in unusable paint rollers with unraveling covers.

### SUMMARY OF THE INVENTION

It is an object of the present invention to provide an improved method for forming a paint roller having a natural skin or lambskin cover.

It is another object of the present invention to provide an on-the-fly method for forming a paint roller having a natural skin or lambskin cover.

It is a further object of the present invention to provide a process for manufacturing a natural skin or lambskin roller without a longitudinal seam therein.

It is yet another object of the present invention to provide a process for manufacturing a natural skin or lambskin roller that is substantially impervious to paint solvents.

The present invention is directed to a method of making a paint roller with a natural skin cover. The method comprises the steps of helically feeding a strip of thermoplastic material about a mandrel. A thermoplastic adhesive is applied upon the outer surface of the strip, the thermoplastic adhesive being at such a temperature and applied in sufficient amount to permit bonding of the suede side of a lambskin and the outer surface of the thermoplastic strip. A strip of lambskin is helically fed over the thermoplastic adhesive and about the mandrel in such a manner as to cause an abutting of the upstream edge of one wind with the downstream edge of the preceding wind, the strip of lambskin being wide enough to accommodate shrinkage. A compressive force is applied upon the lambskin urging the lambskin toward the strip, thereby creating the paint roller.

The present method is further directed to a method of making a paint roller comprising the steps of: helically winding a strip of thermoplastic material around a mandrel so as to form a helically wound strip and advancing the wound strip along the mandrel. A layer of adhesive is applied onto an outer surface of the wound strip, and a strip of natural skin cover material is helically wound about the wound strip and over the layer of adhesive, thereby bonding the strip of cover material to the wound strip for forming the paint roller.

The present invention is further directed to a cold core method of making a paint roller from a cold, hard, preformed hollow core of thermoplastic material of a predetermined length in which the cold hard hollow core and its associated natural skin cover are forged together to form a single unitary body. The step comprising the method include providing a cold hard hollow core composed of a thermoplastic material capable of being fused to a natural skin cover to form a single unitary body. A mandrel having an external diameter is provided which slidably receives and makes contact with the cold hard hollow core. The cold hard hollow core is rotated and heated by application of a single source of heat so that the exterior surface of the cold hard hollow thermoplastic rotating core reaches a temperature high enough to cause subsequently applied suede to adhere to said exterior surface. A suede side of a natural skin strip is applied to the heated exterior surface of the cold hard hollow thermoplastic core, the natural skin strip being wide enough to accommodate shrinkage, thereby bonding the suede to the heated exterior surface thereof, and forming a paint roller.

The present invention is further directed to a method for making a paint roller comprising the steps of helically winding two or more strips of thermoplastic material in overlapping relation, thereby forming a tubular core. A liquid thermoplastic material is then applied to the two or more strips, thereby bonding the two or more strips together. An adhesive is applied to the outer surface of the core and a suede side of a natural skin cover strip is wrapped about the core over the adhesive, wherein the natural skin strip is wide enough to accommodate shrinkage. The natural skin cover is permitted to shrink and to bond to the core, thereby forming the paint roller.

The present invention is further directed to a method for continuously producing a multi-strip laminate paint roller. A first strip of polypropylene material is fed about a mandrel. The first strip of polypropylene material is advanced along the mandrel while simultaneously rotating the first strip of polypropylene material about the mandrel to helically wind the first strip. A second strip of polypropylene material is fed about the first strip of polypropylene material in continuous overlapping relation therewith, with an outer surface of the first polypropylene strip and an inner surface of the second polypropylene strip having a liquid film of polypropylene material there-between. A natural skin cover strip having an inner suede surface is fed about the second polypropylene strip, with an outer surface of the second polypropylene strip and the inner suede surface of the cover having an adhesive therebetween.

The present method is further directed to a method for continuously producing a continuous multi-strip laminate paint roller. A first strip of thermoplastic material is fed about a mandrel. A second strip of thermoplastic material is fed about the first strip of thermoplastic material in overlapping relation. A width of a adhesive is applied upon: a portion of the outer surface of one wind of the first strip, an adjacent portion of the outer surface of a subsequent wind of the first strip, and substantially all of the outer surface of a wind of the second strip. A natural skin cover sufficiently wide to accommodate shrinkage is fed about the second strip and a compressing force is applied upon the natural skin cover urging the cover toward the second strip and simultaneously urging the second strip toward the first strip, thereby creating the continuous multi-strip laminated paint roller.

The present invention is also directed to a paint roller. The paint roller comprises a helically wound inner strip of polypropylene having a inner diameter within the range of approximately 0.5 and 1.5 inches, a helically wound outer strip laminated to the inner strip, and a helically wound natural skin cover affixed to the outer strip by a thermoplastic material consisting of mostly polypropylene. The lamination is formed by the application of liquid polypropylene between the inner and outer strips.

The present invention is also directed to an improved paint roller including a tubular core and a lambskin cover on the core. The improved paint roller has a tubular core comprising thermoplastic material and a lambskin cover heat fused to the surface of the core by heat softening the thermoplastic material without an intermediate adhesive.

The invention is further directed to a method for continuously producing a multi-strip laminate paint roller. The method comprises the steps of helically winding a first strip of polypropylene material about a mandrel, the first strip having an inner and an outer surface. An adhesive is applied to the outer surface of the first strip at a location where the inner surface of the first strip is in contact with the mandrel. A second strip of polypropylene material is helically wound about the first strip, thereby covering the adhesive on the outer surface of the first strip, the second strip being helically wound in overlapping relation to the first strip and the second strip having an inner and an outer surface. An adhesive is applied to the outer surface of the second strip. A natural skin cover strip wide enough to accommodate shrinkage is helically wound about the second strip, thereby covering the adhesive on the outer surface of the second strip. A compressing force is applied upon the cover urging the cover toward the second strip and simultaneously urging the second strip toward the first strip, thereby creating the continuous laminated paint roller.

The method is further directed to a method for continuously producing a multi-strip laminate natural skin covered paint roller. The method comprises helically winding an inner and an outer strips of polypropylene material about a mandrel in overlapping relation. A layer of liquid polypropylene material is applied between the two strips and on the outer surface of the outer strip. Prior to permitting the layer of liquid polypropylene to set, a lambskin cover is wrapped around the outer strip, the lambskin cover being wide enough to accommodate shrinkage. A compressing force is applied upon the cover urging the cover and the two strips toward the mandrel, thereby creating the continuous laminated natural skin covered paint roller.

The invention is further directed to a paint roller comprising a helically wound inner strip of polypropylene having an inner surface and an outer surface, the inner strip having a inner diameter within the range of approximately 0.5 and 1.5 inches; a helically wound outer strip having an inner surface and an outer surface, the inner surface of the outer strip being fused to the outer surface of the inner strip by softened polypropylene on at least one of the outer surface of the inner strip and the inner surface of the outer strip; and a helically wound natural skin cover strip wide enough to accommodate shrinkage affixed to the outer strip by softened polypropylene between the outer strip and the cover.

### BRIEF DESCRIPTION OF THE DRAWINGS

FIG. 1 (prior art) shows a lambskin pelt marked for cutting skins to make covers for a paint roller;

FIG. 2 (prior art) shows two irregular areas of a pelt sewn together;

FIG. 3 (prior art) shows a partially sewn lambskin cover;

FIG. 4 (prior art) shows a sewn lambskin cover being prepared for insertion of the core;

FIG. 5 (prior art) shows a sewn lambskin cover being slid onto a lubricated core;

FIG. 6 shows a diagrammatic representation of an apparatus suitable for making rollers in accordance with one embodiment the present invention;

FIG. 7 depicts problems resulting from manufacturing paint rollers having natural skin covers;

FIG. 8 is a cutaway view of a novel natural skin covered paint roller formed using a single strip embodiment of the present invention;

FIG. 9 shows a diagrammatic representation of an apparatus suitable for making natural skin covered paint rollers in accordance with a laminated strip embodiment the present invention;

FIG. 10 shows a diagrammatic representation of an apparatus suitable for making natural skin covered paint rollers in accordance with another laminated strip embodiment the present invention;

FIG. 11 is a cutaway view of a novel natural skin covered paint roller formed using a laminated strip embodiment of the present invention;

FIG. 12 shows a diagrammatic representation of an apparatus suitable for making natural skin covered paint rollers in accordance with a preformed core embodiment the present invention;

FIG. 13 is a cutaway view of a novel natural skin covered paint roller formed using a preformed core embodiment of the present invention.

### DETAILED DESCRIPTION OF THE INVENTION AND THE PREFERRED EMBODIMENT

Turning first to the prior art, with reference to FIG. 1, a lambskin or other natural skin pelt 1 is marked with gridlines 5. The gridlines 5 are spaced sufficiently to permit the pelt 1 to be cut into a plurality of roller covers. To make a standard 9 inch roller having a 1.5 inch core, it is well known that the pelt 1 is marked with gridlines 5 forming rectangles 2 slightly over 9 inches in the lengthwise dimension and substantially equal to the circumference of the outer portion of the core of the roller in the widthwise dimension.

Due to the irregular shape or other irregularities of a pelt 1, some marked often a first area 3 of the pelt 1 does not form a rectangle. An operator must determine whether the process of cutting and sewing irregular pieces 3, 4 is less costly time wise that the waste that would otherwise occur in the material. When this happens, a second area 4 of the pelt 1 is marked using gridlines 5 in a size and shape somewhat larger than the portion missing from the first area 3.

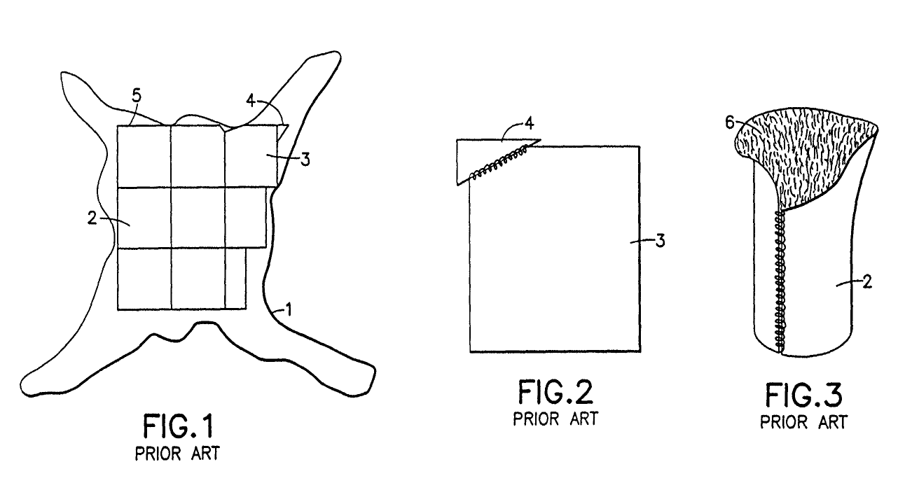

Once the gridlines 5 are marked on the pelt 1, the pelt 1 is cut along the gridlines 5 to separate the rectangles 2 and irregular pieces 3, 4. Once cut, the rectangles 2 may be formed into paint roller covers. In the event, however, that a first area 3 of the pelt 1 does not form a rectangle, as shown in FIG. 2, prior to further processing, the second area 4 is sewn thereto. The resulting shape is then re-cut to form the same shape as the rectangle 2.

The aforementioned prior art layout and cutting process is very time consuming. Moreover, the lay out of specific fixed sized rectangles 2 on the highly irregular shapes of animal pelts with their inherent imperfections and blemishes results in large wasted portions of the skin 1.

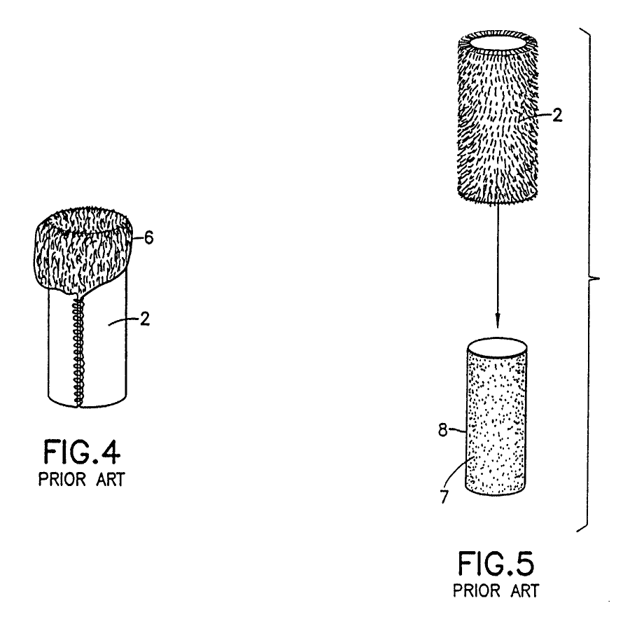

Once the skin 1 is cut to size 2, the cut skin is then sewn together along its length. FIG. 3 shows a partially sewn rectangle 2. To accommodate the sewing machines and the operators, the cut skin 2 is sewn inside out, that is with the fibers 6 facing inward. The stitched seam or seams of the resulting tube shaped product are then processed, as is well known in the art, to permit the tube 2 to lay flat when it is finally placed on the core (not shown). After the seams are processed, the tube 2 is then reversed to make it right-side in, with the fibers 6 facing outward. A partially reversed tube 2 is shown in FIG. 4.

Turning to FIG. 5, the surface of core 8 is coated with an epoxy or other adhesive 7 that has a lubricating characteristic when it is wet. The core 8 is typically made from paper, phenolic or plastic, and the epoxy or adhesive 7 is selected to be compatible with the material of the core 8. To form the paint roller, the now-right-side-in cover 2 is slid down over the entire length of the core 8 which had previously been lubricated with the epoxy or adhesive 7. Once the cover 2 completely covers the core 8, and preferably overlapping each end of the core 8 by a small amount, the epoxy or adhesive 7 is allowed to set. After the epoxy or other adhesive 7 dries, the ends of the paint roller are finished, and the product is complete.

The epoxy or adhesive 7 bonds the cover to the core sufficiently to prevent the cover from laterally sliding off the core. Because the cover 2 has been sewn, only a relatively small amount of adhesive strength is required to permit the cover 2 to resist lateral movement and prevent the cover 2 from disengaging from the core 8.

Due to high quality man-made fibers, the general complexity of working with the natural skins, the limited range of epoxies that work with natural skins, and the poor selection of core materials that are used with such epoxies, very few manufacturers continue to make natural skin paint rollers, and the ones that do, continue to make them by hand, using an inefficient and highly labor intensive process.

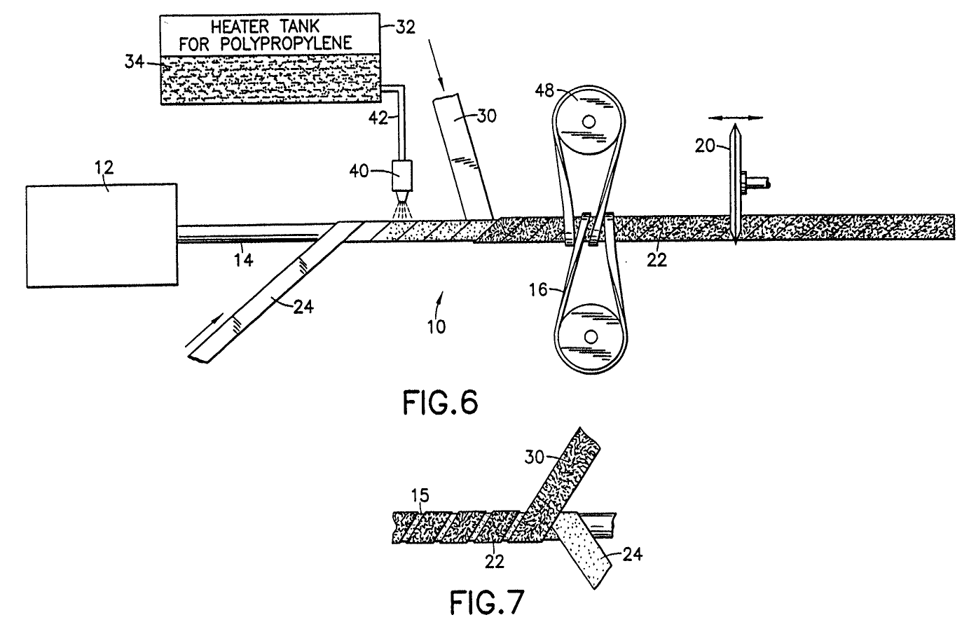

Turning now to FIG. 6, an apparatus suitable for making rollers in accordance with a first embodiment of the present invention is generally designated as 10. The apparatus 10 is similar to apparatus used to manufacture paint rollers with a man-made cover, as, for example, disclosed in U.S. Pat. Nos. 5,572,790, 5,195,242, and co-pending U.S. patent application Ser, No. 09/304,862 filed May 4, 1999 (all incorporated herein by this reference), all invented by the inventor herein. The apparatus 10 components include a housing 12 supporting a stationary mandrel 14, a driven belt 16 wound about the formed endless roller 22 for advancing it in a downstream direction (to the right in FIG. 6), a flyaway cutter 20 for cutting the formed endless roller 22 into usable lengths, and feeders or journaled spindles (not shown) for supporting the roll or supply (also not shown) from which the strip 24, and the natural skin cover 30 are drawn.

The apparatus 10 further comprises a demand heater 32 which can be an extruder for maintaining a liquid supply of thermoplastic material, preferably liquid polypropylene 34, an applicator 40 connected by feed tubes 42 to the heater 32 for applying the liquid polypropylene at a predetermined point in the process, and the use of thermoplastic strip 24 again preferably polypropylene, as the substrate of the core.

The present invention differs from the prior patents and applications in that a natural skin, such as lambskin is used as the strip 30, rather than using a fabric strip, as is well known. It is well know that for a given set of dimensions of the desired roller core, a given width of fabric strip is used for winding. And the fabric strip is fed onto and about the mandrel at a known angle. In the prior art, a fabric strip of typically 2⅞ inches is wound over a thin layer of adhesive that is applied to the outer surface of the strip to manufacture a 1.5 inch roller using a 30 mil thickness strip 24. When the layer of adhesive sets, the cover strip and the strip form an integrated endless roller.

When the inventor replaced the fabric strip with a natural skin strip 30, and manufactured paint rollers in accordance with the single strip teaching of the inventor's '790 patent, two problems arose with the finished product. First, as is common with other wound natural skin rollers, the cover strip 30 did not adequately adhere to the resulting paint roller 22. Thus, although the endless roller 22 appeared fully integrated, when paint rollers were cut from it, the unraveling would easily start. The failure of the cover strip 30 to adequately adhere would result in an unraveling of strip 24 at its ends. The second problem with the resulting endless roller 22 was that the edges of the natural skin cover 30 did not abut, as shown in FIG. 7, gaps 15 were present between successive winds of the natural skin strip 30, and the successive winds of the natural skin cover 30 and the strip 24 would readily unwind.

To remedy these problems, the inventor tried several alternatives, first the inventor attempted processing the underside of the natural skin cover 30 in a variety of manners. For example, the inventor tried perforating the underside of the natural skin 30 with varying size holes, grooving the underside of the skin 30 using leather tools. The inventor also attempted processing the outer surface of the strip 24, by, for example, using a strip 24 having grooves therein and using another strip 24 having miniature spikes thereupon. While meeting with limited success combining the various processing to the strip 24 and the natural skin cover 30, no preferred combination was achieved.

Instead, the inventor determined that the amount of adhesive 34 dispensed on the outer surface of the strip 24 from applicator 40 should preferably be increased from the amount that would be used with a prior art fabric cover. The inventor believes that a generous application of the polypropylene penetrates sufficiently deep into the natural skin 30 to securely affix it and make an integrated endless roller, that will retain integrity when cut into usable products.

In a preferred embodiment, the natural skin strip 30 is provided in a width wider than would be considered proper in the art, for example in a width of 3 inches instead of 2⅞ inches. The inventor believes that the gaps 15 (shown in FIG. 7) are the result of shrinkage caused by the adhesive 34, and that such wide strip accommodates the shrinkage to produce a gap-free roller.

The combination of a more generous application of adhesive 34 coupled with the use of a wider cover strip 30 produce superior results.

The inventor then applied the new technique for on-the-fly manufacturing of natural skin covers to the technique for manufacturing paint rollers disclosed in the inventors '242 patent and found that the process also forms a superior roller, this one having a laminate core.

The inventor also found that the inventive method for on-the-fly manufacturing of natural skin covers produced high quality rollers when used in conjunction with the manufacturing process disclosed in the inventors co-pending U.S. patent application Ser. No. 09/304,862 filed May 4, 1999.

The present invention is believed similarly applicable to any manufacturing process using warmed thermoplastics to adhere a fabric cover to a core made substantially from polypropylene, such as the methods disclosed in U.S. Pat. No. 5,862,591 issued in January 1999 to Kulkaski, U.S. Pat. No. 5,694,688 issues in December 1997 to Musch et al., RE 35,526 issued in June 1997 to Garcia, U.S. Pat. No. 4,692,975 issued in September 1987 to Garcia, U.S. Pat. No. 5,137,595 issued in August 1992 to Garcia, U.S. Pat. No. 5,206,968 issued in May 1993 to Bower et al., U.S. Pat. No. 5,273,604 issued in December 1993 to Garcia, and U.S. Pat. No. 5,397,414 issued in March 1995 to Garcia et al., U.S. Pat. No. 5,614,047 March 1997 issued to Garcia, all incorporated herein by this reference provided that a natural skin cover is provided in a strip wider than the strip man-made fabric cover strip it is replacing, and by providing a sufficient amount of warmed polypropylene or other thermoplastic to cause the natural skin cover to retain integrity with the paint roller when cut into usable products, and when used as a paint roller.

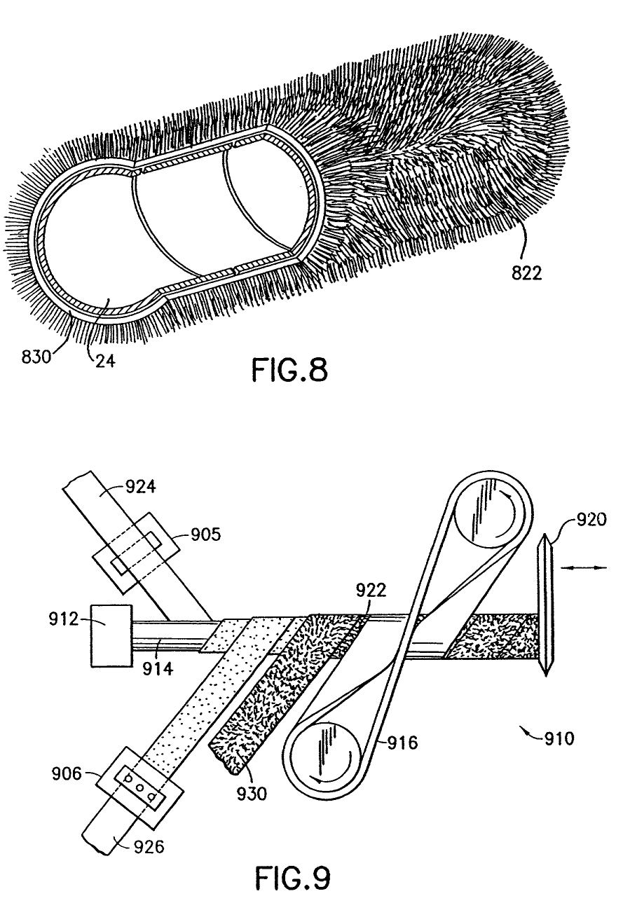

Turning now to FIG. 8, a cutaway view is shown of a novel natural skin covered paint roller 822 made using a single strip process in accordance with the present invention. Inner surface of the single strip 24 is visible in the cavity of the cut roller 822. The natural skin cover 830 is bonded integrally to the inner strip 24.

Turning now to FIG. 9, an apparatus suitable for making rollers in accordance with a laminated core embodiment of the present invention is generally designated as 910. The apparatus 910 components include a housing 912 supporting a stationary mandrel 914, a driven belt 916 wound about the formed endless roller 922 for advancing it in a downstream direction (to the right in FIG. 9), a flyaway cutter 920 for cutting the formed endless roller 922 into usable lengths, and feeders or journaled spindles (not shown) for supporting the roll or supply (also not shown) from which the inner strip 924, the outer strip 926 and the natural skin strip 930 are drawn. The width of the natural skin strip 930 must be sufficient to accommodate shrinkage.

The heater 905 is directed to the outer surface of the inner strip 924 and as the inner strip 924 is passed over the heater 905, the heater 905 heat softens the outer surface of the strip 924. The heat softening must be performed in an amount sufficient to permit subsequent bonding between the outer surface of the inner strip 924 and the inner surface of the outer strip 926. Alternatively, heater 905 could be directed to the inner surface of the outer strip 926 (not shown) and heat soften that surface. The requirement, of course, would be the same, namely, to provide heat softening of a surface in an amount sufficient to permit subsequent bonding between the outer surface of the inner strip 924 and the inner surface of the outer strip 926.

The heater 906 is directed towards the outer surface of the outer strip 926. The heat softening must be performed in an amount sufficient to permit subsequent bonding between the outer surface of the outer strip 926 and the suede side of the natural skin cover 930.

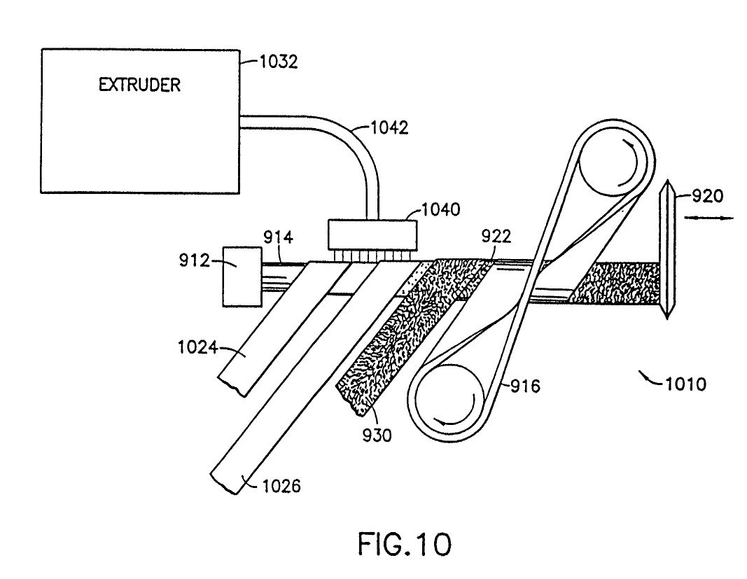

Turning now to FIG. 10, another apparatus suitable for making rollers in accordance with a laminated core embodiment of the present invention is generally designated as 1010. The apparatus 1010 components include a housing 912 supporting a stationary mandrel 914, a driven belt 916 wound about the formed endless roller 922 for advancing it in a downstream direction (to the right in FIG. 10), a flyaway cutter 920 for cutting the formed endless roller 922 into usable lengths, and feeders or journaled spindles (not shown) for supporting the roll or supply (also not shown) from which the inner strip 1024, the outer strip 1026 and the natural skin strip 930 are drawn. The width of the natural skin strip 930 must be sufficient to accommodate shrinkage.

In addition, an extruder 1032 extrudes a supply of thermoplastic adhesive, preferably polypropylene, through a tube 1042, and to the die head 1040. The die head 1040 is preferably of sufficient width to extrude the thermoplastic adhesive over a portion of one wind of the inner strip 924, a portion of an adjacent wind of inner strip 1024 and substantially all of the outer strip 1026. The inner strip 1024 and the outer strip 1026 differ from the inner and outer strips 924, 926 in FIG. 9 because they are generally of a lesser thickness to produce the same thickness paint roller—the thickness is reintroduced by the application of the thermoplastic adhesive thereupon during the manufacturing process.

While the inventor believes the single wide die head 1040 to provide distinct advantages in the simplicity of manufacture of the novel natural skin paint roller, as an alternative two or more smaller die heads (not shown) could be used. The use of two or more die heads would likely require the use of additional tubes (not shown) and possibly additional extruders (also not shown).

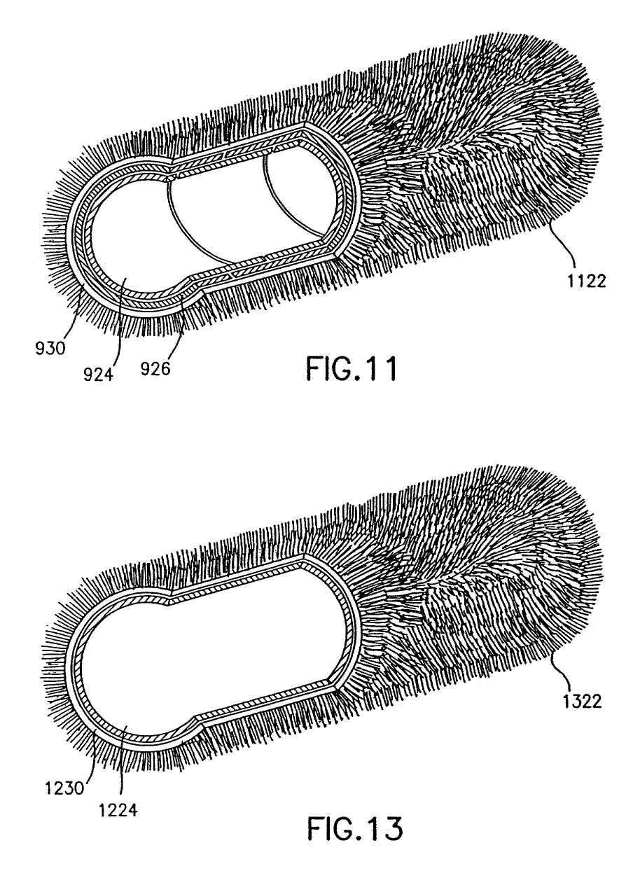

Turning now to FIG. 11, a cutaway view is shown of a novel natural skin covered paint roller 1122 made using a laminate process in accordance with the present invention. Inner surface of the inner strip 924 is visible in the cavity of the cut roller 1122. The outer strip 926 is bonded integrally to the inner strip 924. The natural skin cover 930 is bonded integrally to the outer strip 926 to form an integral roller.

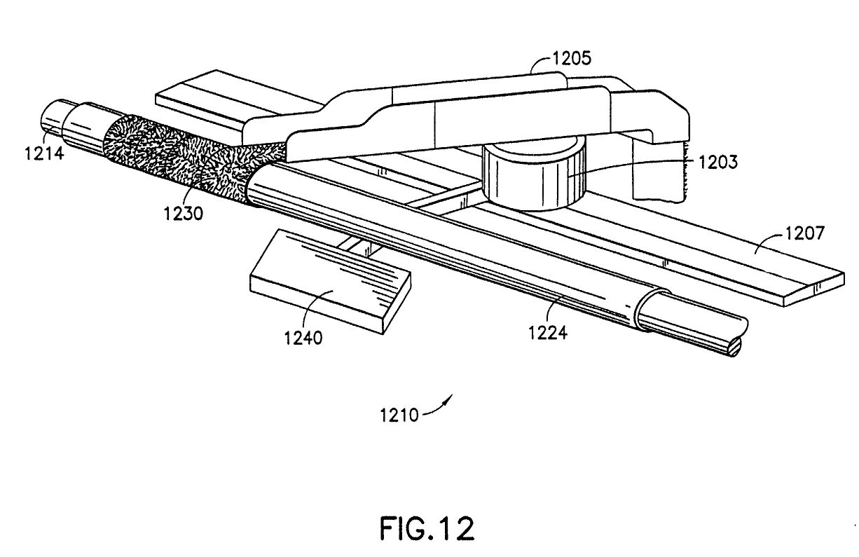

Turning now to FIG. 12, an apparatus suitable for making rollers in accordance with a preformed core embodiment of the present invention is generally designated as 1210. The apparatus 1210 components include a rotating mandrel 1214, a carriage 1203 running on a stationary track 1207 and supporting a natural skin cover support 1205 and a heater 1240. In operation, a preformed core 1224 is placed about the mandrel 1214. Subsequently, the heater 1240 is activated thereby heat softening the outer surface of the preformed core in an amount sufficient to bond the suede side of a natural skin cover to the core 1224. A natural skin strip 1230 is wrapped about the core by the rotation of the mandrel, and the carriage 1203 is moved along in a downstream direction (to the right in FIG. 12) to permit the strip 1230 to wrap about substantially all of the preformed core 1224. The width of the natural skin strip 1230 must be sufficient to accommodate shrinkage.

a driven belt 916 wound about the formed endless roller 922 for advancing it in a downstream direction (to the right in FIG. 10), a flyaway cutter 920 for cutting the formed endless roller 922 into usable lengths, and feeders or journaled spindles (not shown) for supporting the roll or supply (also not shown) from which the inner strip 1024, the outer strip 1026 and the natural skin cover 930 are drawn.

Turning now to FIG. 13, a cutaway view is shown of a novel natural skin covered paint roller 1322 made using a preformed core process in accordance with the present invention. The inner surface of the preformed core 1224 is visible in the cavity of the cut roller 1322. The natural skin cover 1230 is bonded integrally to the outer surface of the preformed core 1224 to form an integral roller.

Advantageously, a paint roller produced according to the present invention can be inexpensively manufactured on-the-fly by a variety of methods and produce a high durable, solvent resistant, integrated paint roller having a natural skin cover.

While the foregoing describes and illustrates the preferred embodiment of the present invention and suggests certain modifications thereto, those of ordinary skill in the art will recognize that still further changes and modifications may be made therein without departing from the spirit and scope of the invention. Accordingly, the above description should be construed as illustrative and not in a limiting sense, the scope of the invention being defined by the following claims.

What is claimed is:

1. A method of making a paint roller, comprising the steps of:
helically feeding a strip of thermoplastic material about a mandrel;
applying thermoplastic adhesive upon the outer surface of the strip, the thermoplastic adhesive being at such a temperature and applied in sufficient amount to permit bonding of the suede side of a lambskin and the outer surface of the thermoplastic strip;
helically feeding a strip of lambskin over the thermoplastic adhesive and about the mandrel in such a manner as to cause an abutting of the upstream edge of one wind with the downstream edge of the preceding wind, the strip of lambskin being wide enough to accommodate shrinkage;
applying a compressive force upon the lambskin urging the lambskin toward the strip, thereby creating the paint roller.

2. The method of making a paint roller claimed in claim 1, wherein the thermoplastic adhesive comprises mostly polypropylene.

3. The method of making a paint roller claimed in claim 2, wherein the thermoplastic material comprises mostly polypropylene.

4. A method of making a paint roller, comprising the steps of:
helically winding a strip of thermoplastic material around a mandrel so as to form a helically wound strip;
advancing the wound strip along the mandrel;
applying a layer of adhesive onto an outer surface of the wound strip; and
helically wrapping a strip of natural skin cover material about the wound strip and over the layer of adhesive, thereby bonding the strip of cover material to the wound strip for forming the paint roller.

5. The method of making a paint roller claimed in claim 4, wherein each of the thermoplastic material and the adhesive comprise mostly polypropylene.

6. The method of making a paint roller claimed in claim 4, wherein the strip of natural skin cover material is wide enough to accommodate shrinkage.

7. A cold core method of making a paint roller from a cold, hard, preformed hollow core of thermoplastic material of a predetermined length in which the cold hard hollow core and its associated natural skin cover are forged together to form a single unitary body comprising the steps of:
providing a hard hollow core,
said hard hollow core being cold,
said cold hard hollow core being composed of a thermoplastic material capable of being fused to a natural skin cover to form a single unitary body,
providing a mandrel having an external diameter which slidably receives and makes contact with the cold hard hollow core,
rotating the cold hard hollow core,
heating, by application of a single source of heat, the exterior surface of the cold hard hollow thermoplastic rotating core to a temperature high enough to cause subsequently applied suede to adhere to said exterior surface,
applying a suede side of a natural skin strip to the heated exterior surface of the cold hard hollow thermoplastic core, the natural skin strip being wide enough to accommodate shrinkage, thereby bonding the suede to the heated exterior surface thereof, and forming a paint roller.

8. The cold core method of making a paint roller from a cold, hard, preformed hollow core of thermoplastic material of a predetermined length claimed in claim 7 wherein the thermoplastic material comprises mostly polypropylene.
